(19) United States
(12) Patent Application Publication
(10) Pub. No.: US 2016/0127417 A1
(43) Pub. Date: May 5, 2016

(54) SYSTEMS, METHODS, AND DEVICES FOR IMPROVED CYBERSECURITY

(71) Applicant: SECaaS Inc., Falls Church, VA (US)

(72) Inventor: Terry L. Janssen, Waterford, VA (US)

(21) Appl. No.: 14/925,730

(22) Filed: Oct. 28, 2015

Related U.S. Application Data
(60) Provisional application No. 62/072,281, filed on Oct. 29, 2014.

(51) Int. Cl. H04L 29/06

(52) U.S. Cl. CPC H04L 63/20; H04L 63/1433; H04L 63/0823; H04L 63/1425; H04L 63/1416

(57) ABSTRACT

Embodiments relate to systems, devices, and computing-implemented methods for initiating a secure network communication system using a response to a risk assessment template and one or more computer knowledge bases to determine a network security policy, network security controls, hardware and software devices, and commands for the hardware and software devices. Embodiments also relate to systems, devices, and computing-implemented methods for monitoring the secure network communication system by monitoring communications from user devices, determining to hold communications based on the network security policy, notifying users of held communications, and allowing the users, via their user devices, to adjust the network security policy for overridable controls to authorize held communications.

### CROSS-REFERENCE TO RELATED APPLICATIONS

This application claims priority to U.S. Provisional Patent Application having Ser. No. 62/072,281, which was filed on Oct. 29, 2014, and is incorporated herein by reference in its entirety.

### TECHNICAL FIELD

The present disclosure relates to systems, devices, and methods for providing improved computer network security capabilities.

### BACKGROUND

Network security systems are often employed to protect internal networks from, for example, misuse, unauthorized modification, malicious software, or denial of network-accessible resources. However, current network security systems are hampered by various difficulties in preventing network security breaches due to attacks and malware. For example, systems that over-identify threats to network security introduce unnecessary delays to network performance. Alternatively, systems that under-identify threats to network security or have inadequate network security for mitigating against those threats leave the networks vulnerable to unknown, new, and/or evolved threats. Inadequate network security can lead to severe risk of loss of data confidentiality, integrity, and availability.

Users have not had adequate protection of digital assets because of human error in provisioning security appliances like firewalls. Data loss prevention has traditionally blocked egress traffic by comparing the network packet contents against pre-defined keywords, watermarks or digital hashes of the file contents. These keywords have applied to all users equally and have not taken into account the individual user's roles and responsibilities. In the case of the word “Confidential” in today's data loss prevention systems, all files regardless of users' role and ownership of the document are blocked from egress, but it may be legitimate and necessary for that user to send that file. Therefore, the typical data loss prevention approach of blocking all egress data packets, regardless of situation, and without potential override by the owner of the asset, is inadequate. Threat intelligence has been collected and used to prevent cyberattacks from being successful, but the application of threat intelligence in real-time to stop loss has not been adequate. Firewalls have rules that can block or allow network packets from Internet ingress and egress, and are capable of much tighter control of ingress or egress network traffic but have not been fully utilized.

Therefore, there is a need for systems, devices, and methods for providing improved computer network security capabilities.

### SUMMARY

Systems, apparatus, computer-readable media, and methods are disclosed for initiating a secure network communication system by sending a risk assessment template to a user device, receiving a response to the risk assessment template comprising a list of one or more assets, determining a score for each of the one or more assets based on the response, determining a network security policy based on the response and the scores using, for example, a network security policy computer knowledge base, determining network security controls based on the network security policy and the response using, for example, a network security controls computer knowledge base, determining a network system design based on the network security policy and the response using, for example, a network system design computer knowledge base, determining at least one hardware element and at least one software element based on the network security policy, determining commands based on the at least one hardware element, the at least one software element, and the network security policy, and transmitting the commands to a security appliance corresponding to the at least one hardware element, whereby the commands cause the security appliance to execute one or more machine-readable rules and security processes corresponding to the network security policy.

Systems, apparatus, computer-readable media, and methods are also disclosed for monitoring communications in a secure network communication system by receiving, at a security appliance (e.g., a trusted internet connection access provider device), commands corresponding to a network security policy, executing the commands to establish one or more network security rules, receiving, from a user device, information corresponding to user device events, wherein the user device comprises an instance of a distributed database, storing the information in a second instance of the distributed database, receiving a communication from the user device, comparing the communication to the one or more network security rules and the information corresponding to the user device events in the second instance of the distributed database, determining to hold the communication based on the comparing, transmitting, to a security operations center, an indication of a network security event based on determining to hold the communication, receiving a command from the security operations center in response to the transmitting, and executing the command, where the command causes the security appliance to block or allow the communication.

Systems, apparatus, computer-readable media, and methods are also disclosed for monitoring communications in a secure network communication system by receiving, at a security operations center, an indication of a network security event from a security appliance (e.g., a trusted internet connection access provider device), comparing the network security event to information in a network security database, determining to notify a user based on the comparing, determining a user device to notify based on a user authorization hierarchy and an asset corresponding to the network security event, sending a notification to the user device, where the notification causes the user device to display an indication of the network security event and display a selection option on whether to allow or block a communication, receiving a response from the user device, determining commands based on the response, and transmitting the commands to the security appliance.

It will be appreciated that this summary is intended merely to introduce a subset of aspects of the disclosure, presented below. Accordingly, this summary is not to be considered limiting on the disclosure.

### BRIEF DESCRIPTION OF THE DRAWINGS

The accompanying drawings, which are incorporated in and constitute a part of this specification, illustrate various embodiments of the present disclosure and together, with the description, serve to explain the principles of the present disclosure. In the drawings:

FIG. 1 is a diagram depicting an example of a secure network communication system, consistent with certain disclosed embodiments;

FIG. 2 is a flow diagram illustrating an example process of initiating a secure network communication system, consistent with certain disclosed embodiments;

FIG. 3 is a flow diagram illustrating an example process of monitoring communications in a secure network communication system, consistent with certain disclosed embodiments;

FIG. 4 is a flow diagram illustrating an example process of monitoring communications in a secure network communication system, consistent with certain disclosed embodiments;

FIG. 5 is a flow diagram illustrating example communications in a secure network communication system, consistent with certain disclosed embodiments;

FIG. 6 is a flow diagram illustrating example communications in a secure network communication system, consistent with certain disclosed embodiments; and

FIG. 7 is a diagram illustrating an example of a hardware system for providing a secure network communication system, consistent with certain disclosed embodiments.

### DETAILED DESCRIPTION

The following detailed description refers to the accompanying drawings. Wherever convenient, the same reference numbers are used in the drawings and the following description refers to the same or similar parts. While several examples of embodiments and features of the present disclosure are described herein, modifications, adaptations, and other implementations are possible, without departing from the spirit and scope of the present disclosure. Accordingly, the following detailed description does not limit the present disclosure. Instead, the proper scope of the disclosure is defined by the appended claims.

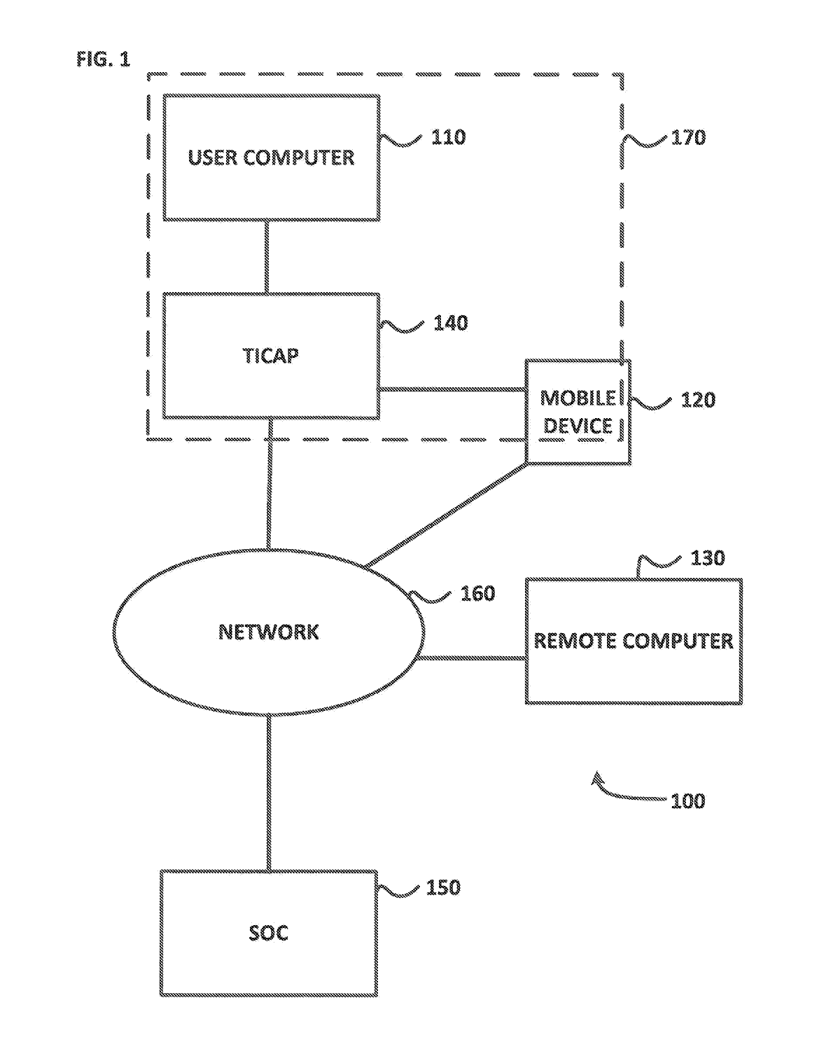

FIG. 1 is a diagram depicting an example of a secure network communication system, consistent with certain disclosed embodiments. In particular, FIG. 1 depicts a secure network communication system 100 that includes a user computer device 110, a user mobile device 120, a remote computer device 130, a trusted internet connection access provider device (TICAP) 140, a security operations center device (SOC) 150, an external network 160, and a local area network (LAN) 170.

In some embodiments, user computer device 110 can represent any type of computing device that can communicate with other devices via one or more networks and display a network security desktop interface, such as, for example, a laptop computer or desktop computer. The network security desktop interface can be used to, for example, notify the user of network security events and allow the user to authorize, deny, defer, via a process described below, and/or further analyze communications associated with the network security events, as discussed in further detail below. In some implementations, user computer device 110 can be connected to TICAP 140 via a LAN. For example, user computer device 110 and TICAP 140 can be connected to a LAN that includes wireless and/or wired connections. In further embodiments, user computer device 110 and TICAP 140 can be connected to user mobile device 120 via a LAN (e.g., LAN 170). In some embodiments, LAN 170 can represent an enterprise network that connects multiple devices for an entity (e.g., a corporation, a department, an organization, etc.).

In various embodiments, user computer device 110 can additionally be connected to a wide area network, such as, for example, network 160. However, in some embodiments, traffic that is sent or received by user computer device 110 is forwarded through TICAP 140 via the LAN. In other words, in such embodiments, network traffic with a destination address of user computer device 110 (i.e., traffic that is sent to user computer device 110) is first received by TICAP 140 and then, if allowed, forwarded to user computer device 110 via the LAN and network traffic with a source address of user computer device 110 (i.e., traffic that is sent by user computer device 110) is first received by TICAP 140, via the LAN, and then, if allowed, forwarded to the destination address (e.g., via network 160).

In some implementations, user computer device 110 can include an instance of a distributed network security database. In such implementations, user computer device 110 can store information, such as indications of user device events and/or indications of network communications involving user computer device 110.

As used herein, “user device events” can represent, for example, an action that occurs at a user device, such as user computer device 110, user mobile device 120, and/or remote computer device 130. In some embodiments, the action can be an action of a user. For example, an action can be letters or words entered from a keyboard or touchscreen into the user device by the user, internet protocol (IP) addresses requested in response to a user's actions, etc. Additionally, “user device events” can represent actions performed by a user device, such as actions that occur in or are performed by an operating system or other applications running on the user device.

In various embodiments, the user device events can be associated with a user identifier that is associated with a specific user. In some embodiment, users can be required to log in to a user device, and the login information provided by the user can be used to determine the user identifier for that user. Accordingly, the user identifier can be associated with user device events that occur while the user is logged in to the user device.

In some implementations, user computer device 110 can aggregate and consolidate the information in the instance of the database and send the consolidated information to TICAP 140 at regular intervals. For example, for data loss prevention beyond file watermarks, keywords and hashes etc., indicators of normal user behavior can include a variety of data that characterizes or “fingerprints” the user. One indicator can be the kinds of words and phrases that a user normally uses that are potential indicators of data loss, such as proper nouns like names of customers, employees, suppliers, etc. If the user has a role like “Human Resources” then emailing employee names in bulk might be typical behavior, but if the user has the role of “Janitor” then this behavior would not be normal. To collect data on “normal” user behavior, user computer device 110 can maintain keyword counts based on words sent by a user while a user is logged into user computer device 110.

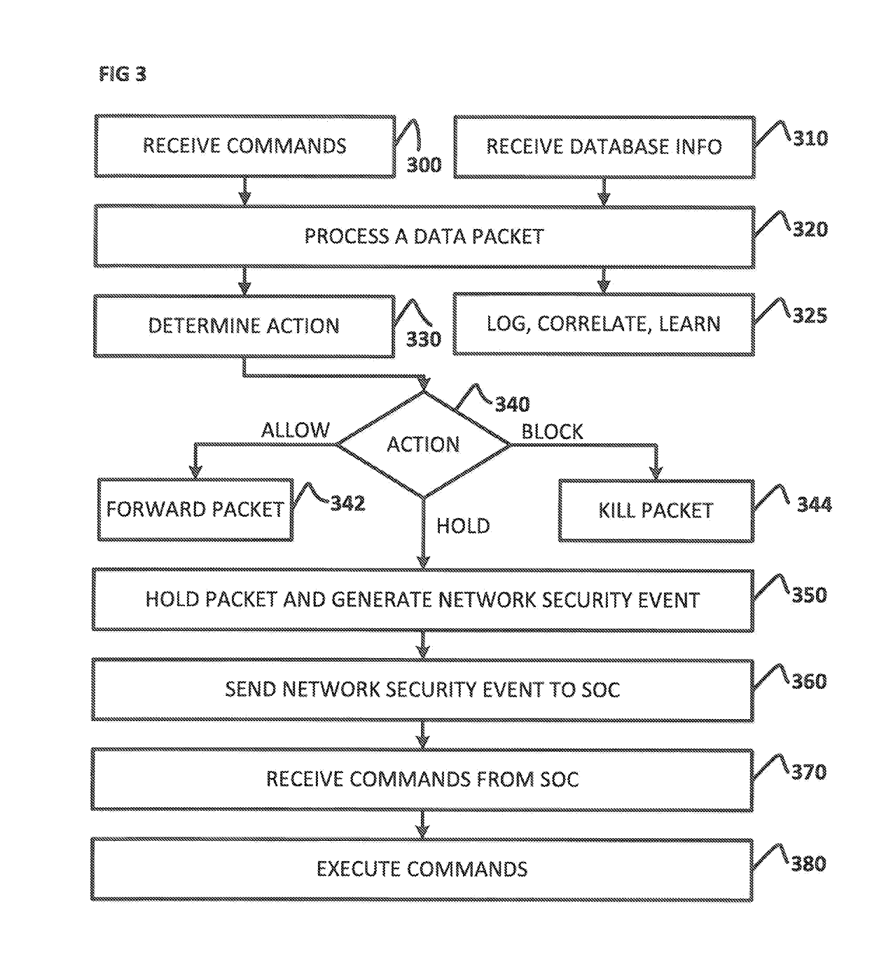

In some embodiments, a data loss prevention rule that triggers a “halt and hold” action, such as in 330 and 340 in FIG. 3, can use a threshold for “normal” user behavior based on the “fingerprint” history on the user, and if the number of keywords reaches a threshold number of abnormal keywords then the “halt and hold” action is performed. Additionally or alternatively, another indicator of normal user behavior can be the frequency at which the user communicates with IP addresses via the Internet. For this example, user computer device 110 can maintain IP address counts associated with communications sent or received while a user is logged into user computer device 110.

In further embodiments, the data loss prevention rule, such as in example 330 and 340 in FIG. 3, if the IP address is “normal” for the user's role, based on accumulated IP address counts for all users with the same role, can be no action, but if the user is communicating with an IP address that has not been used by anyone with that role, and the IP address is unknown, and the geo-location is outside of the organizations normal geo-locations (based on geo-locations of all IP addresses the organization uses), and the protocol is a file transfer protocol, then the “halt and hold” action is performed. In some embodiments, user computer device 110 can accumulate the keyword counts or IP address counts into a session count for a communication session (i.e., a set of communications associated with a single transaction), accumulate the session count into a daily count, accumulate the daily count into a monthly count, and accumulate the monthly count into a yearly count. In further embodiments, the computing device can initialize each count to zero after accumulating the count into the next count. In various embodiments, the daily count, the monthly count, and/or the yearly count can be used to establish normal user behavior.

Some other indicators can include, for example, time of day of the packet egress to the Internet, a protocol, user's device ID, user's Internet IP address (geo-location), etc. The indicators of normal behavior are compared with packet content to determine anomalous behavior that can result in a “halt and hold” action, e.g., 330 and 340 in FIG. 3. The complexity and number of data loss prevention characterizations (“fingerprints”) used in the data loss prevention rules can be very large; this “normal behavior” can be determined by machine learning, as shown in 325 in FIG. 3.

In some embodiments, user computer device 110 can monitor the instance of the database, determine that a suspicious set of user device events or communications occurred (e.g., an unusual operating system event followed by an unusual network communication), and send a communication to TICAP 140 indicating the suspicious set of user device events or communications. For example, a suspicious user device event or communication can be determined by deviation beyond a threshold of normal user behavior. In this example, a user device event might be egress to the Internet, using a file transfer protocol like FTP, initiating a file transfer of over one megabyte (1 MB) of data to an unknown IP address, the user's history of communication with the IP address is zero (0), and the FTP session has reached the threshold of content that is not normal for the user as detected by comparing IP address counts and keyword counts to a corresponding daily count, monthly count, and/or yearly count, respectively.

In further implementations, user computer device 110 can additionally execute a client application that performs functions of TICAP 140. Accordingly, traffic that is sent or received by user computer device 110 is analyzed by the client application before being accessed and/or processed by other applications on user computer device 110 or sent out to TICAP 140. Additionally, user computer device 110 can send communications to the client application that include consolidated information from the instance of the distributed network security database and/or indications of suspicious sets of user device events that occurred on user computer device 110.

In some embodiments, user mobile device 120 can represent any type of mobile computing device that can communicate with other devices via one or more networks and display a network security mobile interface, such as, for example, a mobile phone (e.g., a smartphone) or a tablet computer. The network security mobile interface can be used to, for example, notify the user of network security events and allow the user to authorize, deny, defer, via a process described below, and/or further analyze communications associated with the network security events, as discussed in further detail below. In some implementations, user mobile device 120 can be connected to TICAP 140 via a LAN. For example, user mobile device 110 and TICAP 140 can be connected to a LAN that includes wireless and/or wired connections. In further embodiments, user mobile device 120 and TICAP 140 can be connected to user computer device 110 via a LAN (e.g., LAN 170). In other embodiments, user mobile device 120 may be connected to TICAP 140 via a wide area network (e.g., network 160) and may not be connected to the same LAN as TICAP 140.

In some implementations, traffic that is sent or received by user mobile device 120 is forwarded through TICAP 140 via the LAN. In other words, in such embodiments, network traffic with a destination address of user mobile device 120 (i.e., traffic that is sent to user mobile device 120) is first received by TICAP 140 and then, if allowed, forwarded to user mobile device 120 via the LAN and network traffic with a source address of user mobile device 120 (i.e., traffic that is sent by user computer device 110) is first received by TICAP 140, via the LAN, and then, if allowed, forwarded to the destination address (e.g., via network 160).

In other embodiments, traffic that is sent or received by user mobile device 120 is forwarded through TICAP 140 via a wide area network (e.g., network 160). In other words, in such embodiments, network traffic with a destination address of user mobile device 120 (i.e., traffic that is sent to user mobile device 120) is first received by TICAP 140 and then, if allowed, forwarded to user mobile device 120 via network 160 and network traffic with a source address of user mobile device 120 (i.e., traffic that is sent by user mobile device 120) is first received by TICAP 140, via network 160, and then, if allowed, forwarded to the destination address via network 160. Traffic can be forwarded through TICAP 140 via network 160 when, for example, user mobile device 120 is not connected to the same LAN as TICAP 140 or when user mobile device 120 is connected to the same LAN as TICAP 140 and is also connected to network 160 through a separate network connection (e.g., via a mobile network).

In some implementations, user mobile device 120 can include an instance of a distributed network security database. In such implementations, user mobile device 120 can store indications of user device events and/or indications of network communications involving user mobile device 120.

In some implementations, user mobile device 120 can aggregate and consolidate the information in the instance of the database and send the consolidated information to TICAP 140 at regular intervals. For example, user mobile device 120 can maintain keyword counts or IP address counts, as described above. Alternatively, user mobile device 120 can monitor the instance of the database, determine that a suspicious set of user device events or communications occurred (e.g., an unusual operating system event followed by an unusual network communication, abnormal user behavior, etc.), and send a communication to TICAP 140 indicating the suspicious set of user device events or communications.

In further implementations, user mobile device 120 can additionally execute a mobile application that performs functions of TICAP 140. Accordingly, in such embodiments, user mobile device 120 can communicate via network 160 without being on the same LAN as TICAP 140 or having traffic forwarded through TICAP 140. Instead, traffic that is sent or received by user mobile device 120 is analyzed by the mobile application before being accessed and/or processed by other applications on user mobile device 120 or sent out to another device via a network. Additionally, user mobile device 120 can send communications to the mobile application that include consolidated information from the instance of the distributed network security database and/or indications of suspicious sets of user device events that occurred on user mobile device 120, as described above for user computer device 110.

In some embodiments, remote computer device 130 can represent any type of computing device that can communicate with other devices via one or more networks and display a network security desktop interface, such as, for example, a laptop computer or desktop computer. The network security desktop interface can be used to, for example, notify the user of network security events and allow the user to authorize, deny, defer, via a process described below, and/or further analyze communications associated with the network security events, as discussed in further detail below. In some implementations, remote computer device 130 may be connected to TICAP 140 via a wide area network (e.g., network 160) and may not be connected to the same LAN as TICAP 140.

In some embodiments, traffic that is sent or received by remote computer device 130 is forwarded through TICAP 140 via a wide area network (e.g., network 160). In other words, in such embodiments, network traffic with a destination address of remote computer device 130 (i.e., traffic that is sent to remote computer device 130) is first received by TICAP 140 and then, if allowed, forwarded to remote computer device 130 via network 160 and network traffic with a source address of remote computer device 130 (i.e., traffic that is sent by remote computer device 130) is first received by TICAP 140, via network 160, and then, if allowed, forwarded to the destination address via network 160.

In some implementations, remote computer device 130 can include an instance of a distributed network security database. In such implementations, remote computer device 130 can store indications of user device events and/or indications of network communications involving remote computer device 130. In some implementations, remote computer device 130 can aggregate and consolidate the information in the instance of the database and send the consolidated information to TICAP 140 at regular intervals. For example, remote computer device 130 can maintain keyword counts or IP address counts, as described above. Alternatively, remote computer device 130 can monitor the instance of the database, determine that a suspicious set of user device events or communications occurred (e.g., an unusual operating system event followed by an unusual network communication, abnormal user behavior, etc.), and send a communication to TICAP 140 indicating the suspicious set of user device events or communications, as described above for user computer device 110.

In further implementations, remote computer device 130 can additionally execute a client application that performs functions of TICAP 140. Accordingly, in such embodiments, remote computer device 130 can communicate via network 160 without having traffic forwarded through TICAP 140. Instead, traffic that is sent or received by remote computer device 130 is analyzed by the client application before being accessed and/or processed by other applications on remote computer device 130 or sent out to another device via a network. Additionally, remote computer device 120 can send communications to the client application that include consolidated information from the instance of the distributed network security database and/or indications of suspicious sets of user device events that occurred on remote computer device 120.

In some embodiments, TICAP 140 can represent any type of computing device that can, for example, communicate with other devices via one or more networks, monitor communications on the one or more networks, receive and forward traffic between the other devices, determine whether to block, allow, or “hold” traffic, generate network security events using one or more sensors, receive commands, and execute commands. In various embodiments, TICAP 140 can represent one or more computing devices such as, for example, a laptop computer, a desktop computer, a router, a server, and/or a mainframe computer.

As used herein, a network security event can refer to the determination of a network security incident that requires further analysis and/or processing beyond merely blocking or allowing a communication. Additionally, a network security event can refer to the information that is generated by and/or sent from a detecting device (e.g., TICAP 140) to an analysis device (e.g., SOC 150) in response to the determination of the network security incident. Further, a network security event can refer to an incident and/or a sequence of incidents that triggered the determination.

In further implementations, TICAP 140 can include an instance of a distributed network security database. In such implementations, TICAP 140 can store information (e.g., user device events) received from one or more of user computer device 110, user mobile device 120, and remote computer device 130. In some implementations, TICAP 140 can further aggregate and consolidate the information received from various devices in the instance of the database. In further implementations, TICAP 140 can send the consolidated information to SOC 150 at regular intervals. Alternatively, TICAP 140 can monitor the instance of the database, determine that a suspicious set of user device events or communications occurred (e.g., an unusual network communication from a first device followed by an unusual network communication from a second device, abnormal user behavior, etc.), send information corresponding to the suspicious set of user device events or communications to SOC 150, and/or determine to block or allow a communication based on the suspicious set of user device events or communications.

In some embodiments, SOC 150 can represent any type of computing device that can, for example, communicate with other devices via one or more networks, monitor communications on the one or more networks, determine a network security policy (i.e., a set of rules) for secure network communication system 100, set up user profiles and user authorization hierarchies, maintain the network security policy, process network security events to determine actions, transmit commands, maintain a database of user authentication information, and determine user devices to transmit notifications based on network security events and/or user authorization hierarchies. In various embodiments, SOC 150 can represent one or more computing devices such as, for example, a laptop computer, a desktop computer, a server, and/or a mainframe computer.

In further implementations, SOC 150 can include an instance of a distributed network security database. In such implementations, SOC 150 can store information received from TICAP 140. In some implementations, SOC 150 can further aggregate and consolidate the information received from TICAP 140 in the instance of the database. In further implementations, SOC 150 can monitor the instance of the database, determine that a suspicious set of user device events or communications occurred (e.g., an unusual network communication from a first device followed by an unusual network communication from a second device, abnormal user behavior, etc.), determine to block or allow communications based on the suspicious set of user device events or communications, and/or determine whether to notify a user based on the suspicious set of user device events or communications.

In further embodiments, the instance of the distributed security database can include a global threat intelligence database that includes information related to known global threats, vulnerabilities, etc. that are not unique to a specific secure network communication system. In some embodiments, SOC 150 can further determine actions based on the global threat intelligence database.

In some embodiments, network 160 can represent any type of one or more wide area communications networks. For example, network 160 can include the Internet and/or one or more mobile networks.

The schematic depicted in FIG. 1 is merely for the purpose of illustration and is not intended to be limiting. Further, the secure network communication system depicted is merely a simplified example of a secure network communication system, consistent with certain disclosed embodiments, but such an example is not intended to be limiting. For example, in various embodiments, the secure network communication system can include additional LANs, user computer devices, user mobile devices, remote computer devices, TICAPs, SOCs, and/or other devices or networks.

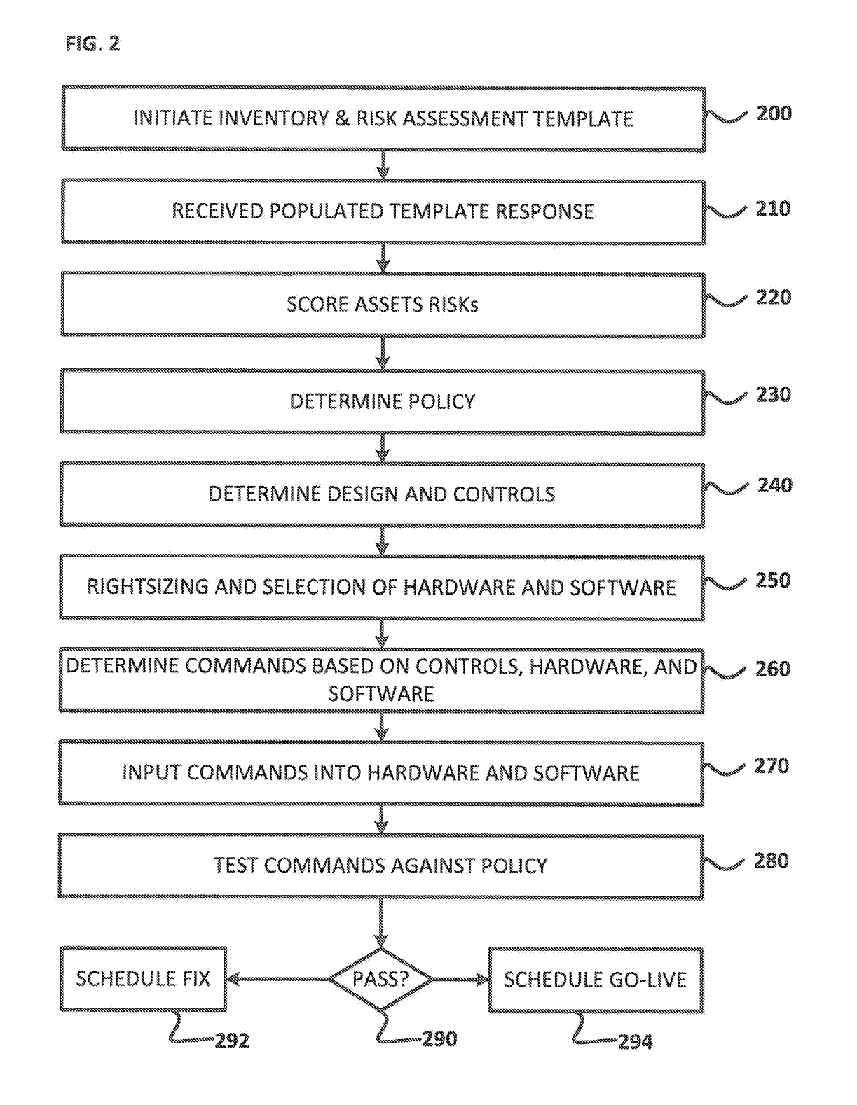

FIG. 2 is a flow diagram illustrating an example process of initiating a secure network communication system, consistent with certain disclosed embodiments. In various embodiments, the process can be performed using one or more computing devices. For example, the process can be performed by SOC 150, as described in FIG. 1.

The example process can begin in 200 when the computing device sends an inventory and risk assessment template to a user device. For example, the computing device can send the risk assessment template to user computer device 110 via email or via a secure website that requires user authentication. In some embodiments, the risk assessment template can be any type of file or document that includes risk assessment questions for a user. For example, the risk assessment template can request that the user list data assets and other assets such as user devices, server devices, databases, networks, software, personnel, etc. Additionally, for example, the risk assessment template can request that the user answer questions related to the assets, such as value, requirements, level of confidentiality, level of availability, asset ownership, personnel authorized to permit access, division within a corporation associated with asset, desired network security properties (e.g., tight security controls), etc. Further, for example, the inventory and risk assessment template can request that the user provide data related to company artifacts, including, as-is network architecture topology, existing cybersecurity controls, personnel, personnel roles and responsibilities, information on network and user devices, software, customers, suppliers, associated data assets, estimated values of data assets, impacts of lost or unavailable data, and probability of data loss.

In 210, the computing device can receive a response to the inventory and risk assessment template from the user device. In some embodiments, the response can include answers to the risk assessment questions and lists of assets, personnel, etc.

In 220, the computing device can determine risk assessment scores for assets listed in the response. In some embodiments, the computing device can score the assets using the Risk Management Framework (RMF) developed by the Joint Task Force Transformation Initiative Working Group. For example, the computing device can compute exposure values of assets, single and annualized loss expectancies of assets, etc.

Additionally, in some embodiments, the computing device can create user profiles for personnel listed in the response. In some implementations, the user profiles can be associated with a unique user identifier that can be used to associate users with user device events (e.g., as discussed above). Further, the user profiles can indicate the assets owned by the corresponding user. In various embodiments, the user that owns the asset can be the first user that is notified of a network security event involving the asset, as discussed in further detail below. In some embodiments, users can configure their corresponding user profile to, for example, indicate whether they want to receive notifications of network security events. If a user indicates that they do not want to receive notifications of network security events, the computing device can determine a user to send notifications to using a user authorization hierarchy, as discussed below.

In 230, the computing device can determine a network security policy based on the risk assessment scores for the assets. In various embodiments, a network security policy can be a listing of machine-readable rules that represent a network security policy and associate events (e.g., network security events and/or user device events) or sequences of events with a sequence of actions.

In some embodiments, the computing device can determine the network security policy using a network security policy computer knowledge base. For example, the computing device can compare information about an asset and a score for the asset to information in the knowledge base corresponding to the same or similar asset with the same or similar score. Accordingly, rules in the network security policy can be determined, at least in part, based on rules for the same or similar asset in the knowledge base with the same or similar score. In some embodiments, the information about the asset, the score for the asset, and the rules created for the policy can be stored for future use.

In further embodiments, the computing device can additionally determine the network security policy based on a global threat intelligence database. In various embodiments, the global threat intelligence database can include information related to known global threats, vulnerabilities, etc. that are not unique to a specific secure network communication system. Accordingly, the network security policy can include rules for managing the known global threats.

In some embodiments, the computing device can update the network security policy based on changes in the global threat intelligence database. For example, if a new global threat is identified, the computing device can update the rules of the network security policy to manage the new global threat.

In 240, the computing device can determine a network system design of the secure network communication system and determine one or more network security controls. In some embodiments, network security controls can represent types of hardware, types of software, and/or procedures to be performed by the hardware and software based on a network security policy in a secure network communication system. For example, the computing device can compare information about a rule in the policy to information in a network security controls computer knowledge base corresponding to the same or similar rule. Accordingly, the network security controls can be determined, at least in part, based on controls for the same or similar rule in the knowledge base. In some embodiments, the information about the rule and the control determined can be stored for future use.

In various embodiments, the network security controls can be categorized into two or more categories. For example, a first category of network security controls can be non-overridable controls, and can include anti-virus blocks, data encryption controls (e.g. file encryption and/or secure tunnels), user identification, intrusion blocking, secure tunnel inspection, system information and event logging, Trusted Platform Module (TPM) controls, etc. Non-overridable controls can represent controls that cannot be altered by users of the secure network communication system. Additionally, for example, a second category of network security controls can be overridable controls, and can include access management controls, application controls, data loss prevention blocks, data controls, password resets, quarantined email controls, secure tunnel usage controls, static routing controls, user access to virtual domains (VDOMs), roles and privileges controls (e.g., write, read, edit, and delete), VDOM usage controls, and website blocking controls. Overridable controls can represent controls that can be altered by certain users of the secure network communication system. However, in various embodiments, when a user does override a control, that override event can be logged in a database with a non-repudiation associated with that user, such that the user will not be able to successfully dispute that fact that the user authorized the override. In some embodiments, the non-repudiation can be logged by storing a digital certificate of the user in the database.

In some embodiments, the computing device can determine the design of the secure network communication system by segmenting devices and assets in the secure network communication system into one or more virtual domains (VDOMs). In various embodiments, a virtual domain can represent a logical separation of a system and assets based on one or more factors. For example, a virtual domain can be created for devices and assets corresponding to a specific division within a corporation, corresponding to a specific subset of users, corresponding to a specific subset of devices and/or assets that have similar network security properties (e.g., are considered highly valuable and/or confidential), corresponding to company artifacts (e.g., as-is network architecture topology and/or existing cybersecurity controls), etc.

Once the VDOMs are determined, the computing device can identify logical and physical control locations in the secure network communication system, and the computing device can determine device and user access rights for the VDOMs. In some embodiments, the computing device can also maintain a user authorization hierarchy in the secure network communication system. For example, the user authorization hierarchy can indicate which user(s) will be notified of network security events in the event that the owner of the associated asset is unavailable and which user(s) have authority to change overridable controls with regard to assets or devices within a VDOM.

In some embodiments, the computing device can also determine firewall objects and rules for the VDOMS. For example, a firewall object can be a destination IP address or domain name that is to be blocked. In further embodiments, one VDOM can have different rules than a second VDOM. For example, if a VDOM relates to assets and/or devices that require tighter security based on the network security policy, the VDOM can have stricter network security rules.

In further embodiments, the computing device can determine access times for the VDOMs. For example, a user can be allowed access into a VDOM for specified time periods (e.g., from 9 AM to 5 PM on weekdays).

In 250, the computing device can select hardware and software for use in the secure network communication system based on the network security controls. For example, the computing device can select a FortiGate 5000 series security appliance that runs the FortiOS operating system (e.g. FortiOS version 5.2.2). In some implementations, at least one hardware element can be represented by TICAP 140 in FIG. 1.

In some embodiments, the computing device can select the hardware based on whether the hardware can be configured in a manner consistent with the network security controls, whether the hardware can handle the expected processing that will be required, etc. For example, the computing device can, using a hardware computer knowledge base, determine a model number of one or more devices based on the controls, determine the costs associated with the one or more devices, compare the costs to the risk assessment scores and determine whether the costs exceed an appropriate amount based on the risk assessment scores. If the costs exceed the appropriate amount, the process can return to 240 and determine alternate controls. Otherwise, the process can proceed. In some embodiments, the information about the control and the hardware determined can be stored for future use.

In further embodiments, the computing device can select the software based on whether the software provides features consistent with the network security controls, whether the software is compatible with other selected software and/or hardware, etc.

In various embodiments, the computing device can determine a hardware device make and model and software and software version number that can be implemented to enforce the control, using information in a hardware computer knowledge base and/or a software computer knowledge base.

In 260, the computing device can determine the commands to be sent to the hardware and software identified using the hardware computer knowledge base and/or the software computer knowledge base. Commands can represent specific instructions transmitted to hardware and/or software to implement a policy-control. In some embodiments, the computing device can determine how to configure settings of the selected hardware based on the network security controls. In other embodiments, the computing device can determine how to configure the selected software based on the network security controls. For example, the computing device can compare information about the controls to information in a commands computer knowledge base corresponding to the same or similar hardware and software that was selected. Accordingly, commands for the hardware and software can be determined, at least in part, based on commands for the same or similar hardware, software, and controls in the knowledge base. In some embodiments, the network security controls and the commands for the hardware and software determined can be stored for future use.

In 270, after the hardware and software are installed in the secure network communication system, the computing device can input the determined commands into the selected hardware and software. In some embodiments, the computing device can transmit the commands to the selected hardware and/or hardware running the selected software.

In 280, the computing device can test the commands against the network security policy. In some embodiments, the computing device can transfer network data packets and/or requests for assets to the secure network communication system and determine whether the results of the commands executed by the hardware and software correspond to the network security policy. For example, if the network security policy indicates that a specific network data packet type should be blocked or should generate a network security event (e.g., a network data packet from an unknown or blocked source) the computing device can determine whether the secure network communication system blocks or holds the data packet. As an additional example, if the network security policy indicates that a specific asset should not be accessible by an unknown device, the computing device can determine whether the secure network communication system allows access to the asset by an unknown device.

For example, the computing device can compare information about a command used to enforce policy-controls to information in a testing computer knowledge base corresponding to the expected correct test results. Accordingly, the network security testing procedures can be determined, at least in part, based on tests for the same or similar commands to enforce policy-controls that reside in the knowledge base. In some embodiments, the test results can be stored for future use.

In 290, the computing device can determine whether the commands pass the testing. In some embodiments, if at least one test fails, then the process can proceed to 292 and the computing device can notify a device of an administrative user (e.g., a laptop, mobile device, etc.) that the implemented secure network communication system does not meet the network security policy and schedule fixes to the secure network communication system. In other embodiments, the process may only proceed to 292 if a threshold number of tests fail, at least one test related to an important asset fails, a score corresponding to the tests does not meet a threshold, etc.

Conversely, if the computing device can determine that the commands pass the testing, then the process can proceed to 294 where the secure network communication system is scheduled to go live (i.e., become operational). In some embodiments, the commands can be determined to pass the testing if, for example, all tests pass, a threshold number tests pass, all tests related to important assets pass, a score corresponding to the tests meets a threshold, etc.

While the operations depicted in FIG. 2 have been described as performed in a particular order, the order described is merely an example, and various different sequences of operations can be performed, consistent with certain disclosed embodiments. Additionally, the operations are described as discrete steps merely for the purpose of explanation, and, in some embodiments, multiple operations may be performed simultaneously and/or as part of a single computation. The operations described are not intended to be exhaustive or absolute, and various operations can be inserted or removed.

FIG. 3 is a flow diagram illustrating an example process of monitoring communications in a secure network communication system, consistent with certain disclosed embodiments. In various embodiments, the process can be performed using one or more computing devices. For example, the process can be performed by TICAP 140, as described in FIG. 1 and/or the process can be performed by a hardware element and a software element selected in 250 of FIG. 2.

The example process can begin in 300 when the computing device receives commands. For example, the computing device can receive the commands from SOC 150, as described in FIG. 1, and as described in 270 of FIG. 2. The commands can represent machine-readable rules that can be executed and/or interpreted by the computing device. In some embodiments, the commands can represent the network security policy determined by SOC 150 (e.g., in 230 of FIG. 2).

In 310, the computing device can receive information from one or more devices corresponding to user device events recorded at the devices and stored in instances of a distributed database stored on the devices. For example, the computing device can receive information from user computer device 110, user mobile device 120, remote computer device 130, etc. In some embodiments, the devices can aggregate and/or consolidate the user device events prior to sending the information to the computing device. In further embodiments, a device can send a communication (e.g., in 320 below) corresponding to a user device event upon the occurrence of the event (e.g., a suspicious event). The computing device can store the received information in an instance of the database stored on the computing device. The computing device can further aggregate and consolidate the information received from the devices in the instance of the database. In one embodiment, the database is a distributed network security database which stores data in database nodes local to each device, and all or some of the data stored locally is synchronized with another node of the same distributed network security database in SOC 150. In further implementations, the computing device can send the consolidated information to SOC 150 at regular intervals.

In various embodiments, SOC 150 can include a primary node of the distributed database, TICAP 140 can include a second level node, and user device and other network devices can include third level nodes of the distributed database.

In 320, the computing can process a communication. For example, the communication can be a network data packet that includes a request by a user device in a secure network communication system for a resource from and/or to establish a connection with an outside server, such as a secure tunnel like Secure Shell (SSH) or other type of session. Alternatively, the communication can be a network data packet that includes a request from a device outside the secure network communication system for a resource from and/or to establish a connection with a device in the secure network communication system. Additionally, the communication can be a user device event detected by a user device (e.g., based on a series of events stored in the distributed database), where the user device sends an indication of the user device event to the computing device for storage in an instance of the distributed database on the computing device and/or for further analysis. For example, a user device event can be an indication that the user device is attempting to access a website with a missing certificate of trust, like a Secure Sockets Layer (SSL) Digital Certificate.

The incoming (ingress) and outgoing (egress) packets contain headers that provide data about the packet, such as the IP addresses of the source and destination, the protocol, ports to be used at the source and destination, path traversal from source to destination, etc. The computing device can be configured to detect and analyze information in the communication (e.g., network data packets) based on commands received in 300, similar to a network firewall.

In some embodiments, the computing device can be configured to have a sensor that detects the user's activities, application programs and system processes that correspond with the data packet.

In 330, the computing device can determine an action based on the communication. In some embodiments, the computing device can compare the IP addresses of incoming and outgoing network data packets to a list of known IP addresses to determine the action. In further embodiments, the computing device can compare, for example, the protocol of network data packets, the ports used for transmission of the network data packets, the routing paths of network data packets, etc. to determine the action.

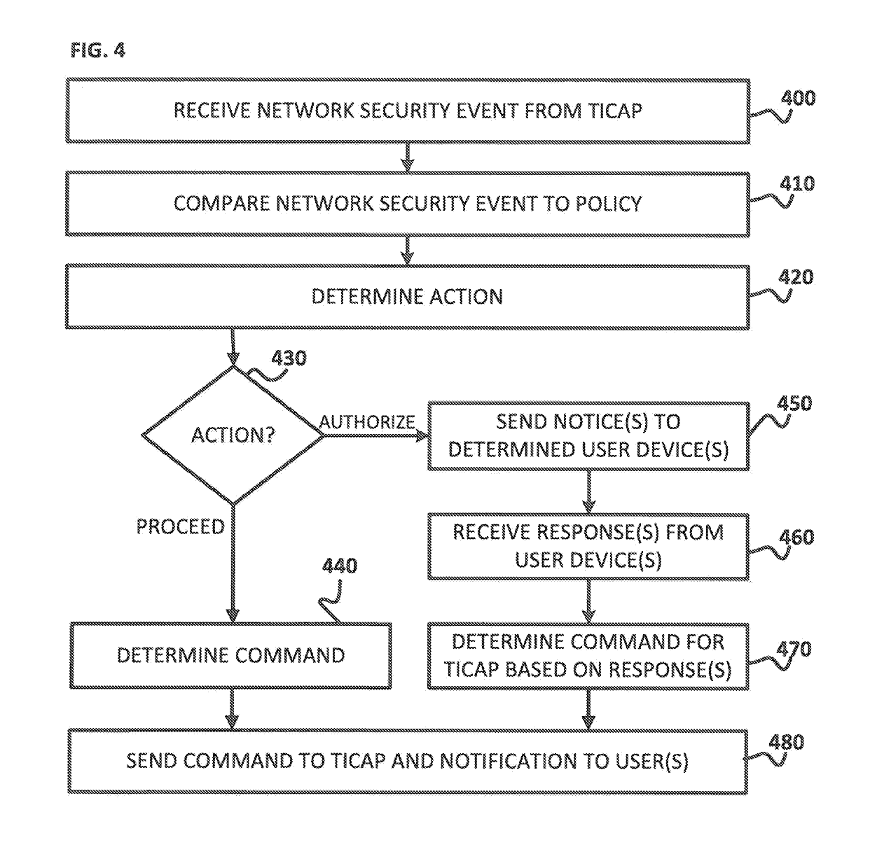

For example, in 340, a data packet can be held due to a website with a missing and/or invalid certificate, etc. The computing device can receive an “allow” action on the held packet when a user device authorizes an “override (shown in 450, 460, 470 and 480 in FIG. 4).

As a further example, in 340, the computing device can determine a “hold” action when the data packet contains content that is suspicious (e.g., as determined by a threat intelligence database). A data packet can be determined to be suspicious, for example, when one or more of the following are observed: when adverse information has been received in the database for the Internet location (IP address), e.g., the IP address is no longer trusted, when the sequence of events related to the data packet are similar to an event pattern that is known to be malicious or suspicious, when a data packet cannot be correlated to an user device event or authorized system process, etc. In various embodiments, a “hold” action can initiate an authorize, deny, defer process, as described below.

As a further example, in 340, the computing device can determine an “allow” action or a “hold” action when a user device attempts to access a website with a missing certificate. In some embodiments, the computing device first attempts to find the missing certificate on the Internet and import the certificate and a certificate revocation list of the certificate. If the imported certificate is “valid” (i.e., not on the certificate revocation list (not revoked)) then the website is not blocked and an allow action is determined. If the imported certificate is not valid, then a hold action can be determined.

In some embodiments, the computing device can determine the “hold” action based on an instance of a distributed network security database stored on the computing device. In some implementations, the database can include the normal behavior patterns of users, referred to here as “fingerprints.” The fingerprints can be determined based on aggregated and consolidated information received from user devices. When the computing device determines that a communication or user device event deviates from normal user patterns, a hold action can be determined. Furthermore, in an embodiment, the instance of the database can include global threat intelligence, such as recent threats, patterns associated with the threats, IP addresses associated with the threats, data from sensors outside the perimeter from the network (e.g., outside of 100 in FIG. 1), and data from sensors internal to a secure network communication system (e.g., 100 in FIG. 1), and other data. The global threat intelligence data can be used to correlate, analyze, and configure commands used by the computing device to allow, block or hold communications.

In further embodiments, the computing device can receive threat intelligence from the Internet and data from sensors inside the secure network communication system and store the information in the instance of the database. In the example, in 325, the results of correlation of packets with related sensor and other data are stored in the database. Common machine learning algorithms are used to learn patterns and rules that are applied to future packet processing, (e.g., in 320) using commands issued in 300. This can include data from network and end point devices, such as personal computers, mainframes, servers, routers, tablet devices, and smart phones, etc. In one embodiment, the instance of the database can be structured using an ontology contained in the knowledge base that relates events for analysis and subsequent courses of action. A course of action can be determined based on policy rules that are processed by a firewall, such as rules that block IP addresses from ingress into the network. In another embodiment, the computing device correlates the user name and processes related user behavior with the network data packets.

In some embodiments, during a hold action the computing device can maintain a session with a device that transferred (sent) the communication. For example, the computing device can adjust a session timer associated with the communication. In other embodiments, during the hold action, the computing device can store information sufficient to recreate the communication and then drop the communication (e.g., end the session). In such embodiments, if the computing device later “allows” the held communication, the computing device can recreate and then transmit the communication.

If, in 340, the computing device determines an allow action, the process can proceed to 342, where the communication is forwarded to its destination. For example, if the communication is an incoming data packet, the data packet can be forwarded to the appropriate user device in the secure network communication system. As an additional example, if the communication is an outgoing data packet, the data packet can be forwarded to a wide area network (e.g., the Internet) for delivery to its final destination outside the secure network communication system.

In some embodiments, the computing device can generate a transaction log entry indicating the allowed action, where the entry includes, for example, the source address of the communication, the destination address of the communication, the protocol used, the port used, the routing path used, the users associated with the communication, the asset associated with the communication, the sequence of user device events associated with the communication, etc. In further embodiments, the entry can be transmitted to SOC 150.

If, in 340, the computing device determines a block action, the process can proceed to 344, where the communication is killed. For example, the communication can be dropped. In some embodiments, a user associated with the killed communication (e.g., a user associated with the source device or the destination device) can be notified that the communication was killed and/or why the communication was killed.

In further embodiments, the computing device can generate a transaction log entry indicating the blocked action, where the entry includes, for example, the source address of the communication, the destination address of the communication, the protocol used, the port used, the routing path used, the users associated with the communication, the asset associated with the communication, the sequence of user device events associated with the communication, etc. In further embodiments, the entry can be transmitted to SOC 150.

If, in 340, the computing device determines a hold action, the process can proceed to 350, where the computing device generates a network security event. In some embodiments, the network security event can include the source address of the communication, the destination address of the communication, the protocol used, the users associated with the communication, the asset associated with the communication, the sequence of user device events associated with the communication, the body of a packet in the communication, etc.

In 360, the computing device can transmit the network security event. In some embodiments, the computing device can send the network security event to SOC 150 and/or the information can be stored locally in the instance of the distributed network security database.

In 370, the computing device can receive commands after transmitting the network security event. In some embodiments, the computing device can receive the commands from SOC 150 after SOC 150 performs the steps described with regard to FIG. 4 (described below). Examples of commands include, but are not limited to, instructions to block a communication, instructions to always block similar communications (e.g., put the respective IP address on the block list), instructions to allow the communication, instructions to allow similar communications for a set period of time (e.g., ten minutes), instructions to always allow similar communications (e.g., put the respective IP address on the allow list), instructions to change a configuration, instructions to remove information from the block list and/or to the allow list, etc.

In 380, the computing device can execute the received commands. For example, the computing device can block a communication, allow a communication, change a configuration, add information to the block list and/or to the allow list, remove information from the block list and/or the allow list, etc.

While the operations depicted in FIG. 3 have been described as performed in a particular order, the order described is merely an example, and various different sequences of operations can be performed, consistent with certain disclosed embodiments. Additionally, the operations are described as discrete steps merely for the purpose of explanation, and, in some embodiments, multiple operations may be performed simultaneously and/or as part of a single computation. The operations described are not intended to be exhaustive or absolute, and various operations can be inserted or removed.

FIG. 4 is a flow diagram illustrating an example process of monitoring communications in a secure network communication system, consistent with certain disclosed embodiments. In various embodiments, the process can be performed using one or more computing devices. For example, the process can be performed by SOC 150, as described in FIG. 1 and/or the process can be performed by the computing device that performs the operations of FIG. 2. In one embodiment, SOC 150 and/or the computing device that performs the operations of FIG. 2 can include instances (i.e., nodes) of a distributed network security database.

The example process can begin in 400 when the computing device receives a network security event. In some embodiments, the computing device can receive the network security event from the computing device performing the operations of FIG. 3 (i.e., in 360), described above (e.g., TICAP 140).

In 410, the computing device can compare the network security event to the network security policy. In some embodiments, the computing device can compare the network security event to the network security policy determined in 230 of FIG. 2. For example, if the network security event is a Halt and Hold event from 350 in FIG. 3 and the network security policy requires two authorizations to override the packet hold, the action determined in 420 below can be to notify two users identified based on a user authorization hierarchy (450 below).

In some embodiments, the computing device can also maintain a database of network security events and global threat intelligence to use with a computer knowledge base to adjust a network security policy. In various embodiments, the computing device can additionally use the database of network security events to determine the action; for example, the action can be to enforce a network security policy by sending commands to one or more TICAPs (480 below).

In some embodiments, the computing device can also maintain a user authorization hierarchy in a secure network communication system. In various embodiments, the computing device can additionally use the user authorization hierarchy to determine the action. For example, the computing device can use the user authorization hierarchy to determine which user device to notify, if a notify action is determined. As an additional example, the computing device can use the network security policy to determine rules on overrides. For example, to determine an order of notifications of users in the user authorization hierarchy and a time lapse before delegation of the next user in the user authorization hierarchy if no response is received.

In some implementations, the user authorization hierarchy (of policy override authority) can include representations of each user that has access to an enterprise network and the respective VDOMs and devices associated with each user (e.g., laptops, desktops, remote devices, mobile devices, etc.). In further embodiments, the user authorization hierarchy can be created based on a corporate structure of an entity that owns and operates the respective VDOMs and other resources within the enterprise network. For example, high-level personnel may have full authority to alter the overridable network security controls at will, either temporarily or permanently, but may not be notified of routine network security events. As an additional example, middle-level personnel (e.g., department leaders) may have limited authority to alter network security controls with regard to assets within their department, and may be notified of all network security events within their department. As a further example, low-level personnel may only have authority to alter network security controls with regard to assets specifically assigned to them and may be notified if a network security event relates to those specific assets.

In 430, if the determined action is proceed, the process can proceed to 440 where the computing device can determine commands associated with the determined action. In some embodiments, the commands can be determined based on the hardware and software associated with TICAP 140. For example, the computing device can compare the determined action to information in the commands computer knowledge base corresponding to the same or similar hardware and software that is associated with TICAP 140. Accordingly, commands for the hardware and software of TICAP 140 can be determined, at least in part, based on controls and commands for the same or similar hardware and software in the knowledge base. In some embodiments, the commands for TICAP 140 determined can be stored for future use. The process can then proceed to 480 where the computing device transmits the commands. For example, the computing device can send the commands to TICAP 140 (e.g., as described in 370 of FIG. 3).

In 430, in one embodiment, if the determined action is to further authorize, then the process can proceed to 450. If the authorization is for release of a “held” data packet and an authorization threshold in the policy database has been met, then the determination can be for a command to be sent to the TICAP to release the held packet. In some cases, “release” means to use stored information to replay the packet, i.e., reinitiate transmission or transaction from the initial step. In some cases, the user requesting the override is also the “owner” authorizer. In some embodiments, the policy determines the level in the authorization hierarchy that is sent the notification. In some embodiments, the default action is to send the notification to the lowest level of the authorization hierarchy, i.e., the user that owns an asset associated with the network security event. In one embodiment, the user profile and other information stored in the database is used in the authorization process, such as, for example, an indication on the user's calendar that she is on vacation triggering automatic delegation to the next user in the user authorization hierarchy, etc. In some embodiments, the user device can be the device of the user that initiated the network security event or a different device, depending upon the device the user has logged into (authenticated on) and depending on whether that device is authorized by policy. For example, the event can occur on a desktop computer and the notification can be sent to the user's smartphone or tablet. In further embodiments, the user that initiates the network security event is not the asset owner, i.e., the user is not in the authorization hierarchy for that event. In this example, that user is the “requesting” user, not the “authorizing” user, and the requesting user waits until the process is completed by the authorizing user. By default the notification can be sent to the lowest level user in the authorization hierarchy for authorize, deny, defer decision processing, and after a decision the result is processed such as shown in 460 and 470, below. The requesting user is then notified of the decision and, if the request is authorized, the requesting user is then provided a 1-click option to release the hold and continue the transaction. For example, if the network security event relates to an asset that, by policy, requires override authorization from two or more users, then the notice is sent to those multiple users on the devices on which those users have authenticated, i.e., logged on (450 in FIG. 4).

In some embodiments, the notice can include instructions that cause the appropriate user device to display a summary of the network security event, a selection option to allow the user to change the controls to authorize a policy override (e.g., change controls classified as overridable), a selection option to allow the user to deny the policy override, a selection option to allow the user to defer the decision to another user (e.g., a new user is selected using the user authorization hierarchy), and a selection option to allow the user to view additional details of the network security event. For example, when an overridable policy requires that a website have a valid certificate but the certificate missing, then the user can request override. How the override can be authorized also depends on policy. If the override requires two users in the authorization hierarchy, and those users both authorize the override, then the requesting user is notified of authorization to access the website for a period of time specified in the authorization. To further this example, the requesting user may be restricted to access of that website from within her own VDOM. In another embodiment, the notification can activate a network security desktop interface application or a network security mobile interface application on the appropriate user device and cause the user device to display the summary, the selection options, etc. In various embodiments, the notice can additionally enable connection of the user device to the computing device over the Internet for receiving the summary, the section options, the additional details, etc.

In further embodiments, the selection option to allow the user to change policy-controls classified as overridable can further allow the user to change the overridable policy-controls permanently or to change the overridable controls for a limited amount of time (e.g., 10 minutes) to authorize the communication and authorize any related subsequent communications for the same transaction. In further implementations, the selection option to allow the user to deny the override can further allow the user to deny similar communications permanently (e.g., change the overridable controls to always block communications corresponding to the same IP address, the same protocol, the same port number, the same pattern (e.g., sequence of user device events), etc.) or to deny the policy-control override only once (i.e., the overridable controls are not changed and the user will be notified the next time a similar network security event occurs).

In some implementations, the notice can include a request for authentication information from the user. For example, the notice can require the user enter authentication information, which is then sent back to the computing device and validated using stored user authentication information. If the authentication information is validated, the computing device can send instructions to the user device to display a summary of the network security event, a selection option to allow the user to change the network security policy-control (for example allowing or blocking a communication), and a selection option to allow the user to view additional details of the network security event.

In one embodiment, a preliminary notice can be sent to the user that initiates the network event. This user might not be the owner of an asset associated with the network event and, accordingly may not have authorization to change a respective control, such as an override to authorize the communication with an IP address. The preliminary notice can include instructions to display on the initiating user's device a summary of the network security event, a selection option to send a notice to a user with appropriate authorization, a selection option to allow the user to deny the communication without sending the notice to the owner, and a selection option to allow the user to view additional details of the network security event. According, if the user accidently or inadvertently initiated the network security event, he or she can block the network security event before further actions regarding the network security event occur. If the initiating user selects to send the notice to the user with appropriate authorization, the notice can be sent, as described above.

In 460, the computing device can receive a response from the user device. For example, the computing device can receive a response that includes authorization information and/or instructions from the user to change overridable policy-controls (e.g., permanently or temporarily change the network security policy). If the instructions are to change an overridable control, the computing device can change the overridable control accordingly. In some embodiments, if the instructions are to change the overridable controls, the computing device can store an indication of the user that authorized the change and an indication of the change in a log of network security control changes. In one embodiment, the details of the authenticated user's digital certificate is permanent archived with a change log (or reference) in secure data storage for the purpose of non-repudiation of the user's authorization of the override, i.e., the user can be held accountable in the event that the change in overridable controls results in a network security failure, such as a data breach.

In some embodiments, responses may be required to be received from two or more users within the authorization hierarchy to effect final authorization and change an overridable control. For example, if a notice was sent to three user devices in 450, the computing device can require at least two responses that include instructions to change the overridable control for the change to be authorized and performed.

In 470, the computing device can determine commands associated with the instructions from the user. In some embodiments, the commands can be determined based on the hardware and software associated with TICAP 140. For example, the computing device can compare the instructions to information in the commands computer knowledge base corresponding to the same or similar hardware and software that is associated with TICAP 140. Accordingly, commands for the hardware and software of TICAP 140 can be determined, at least in part, based on commands for the same or similar hardware and software in the knowledge base. In some embodiments, the commands for TICAP 140 determined can be stored for future use. The process can then proceed to 480 where the computing device sends the commands. For example, the computing device can send the commands to TICAP 140 (e.g., as described in 370 of FIG. 3).

While the operations depicted in FIG. 4 have been described as performed in a particular order, the order described is merely an example, and various different sequences of operations can be performed, consistent with certain disclosed embodiments. Additionally, the operations are described as discrete steps merely for the purpose of explanation, and, in some embodiments, multiple operations may be performed simultaneously and/or as part of a single computation. The operations described are not intended to be exhaustive or absolute, and various operations can be inserted or removed.

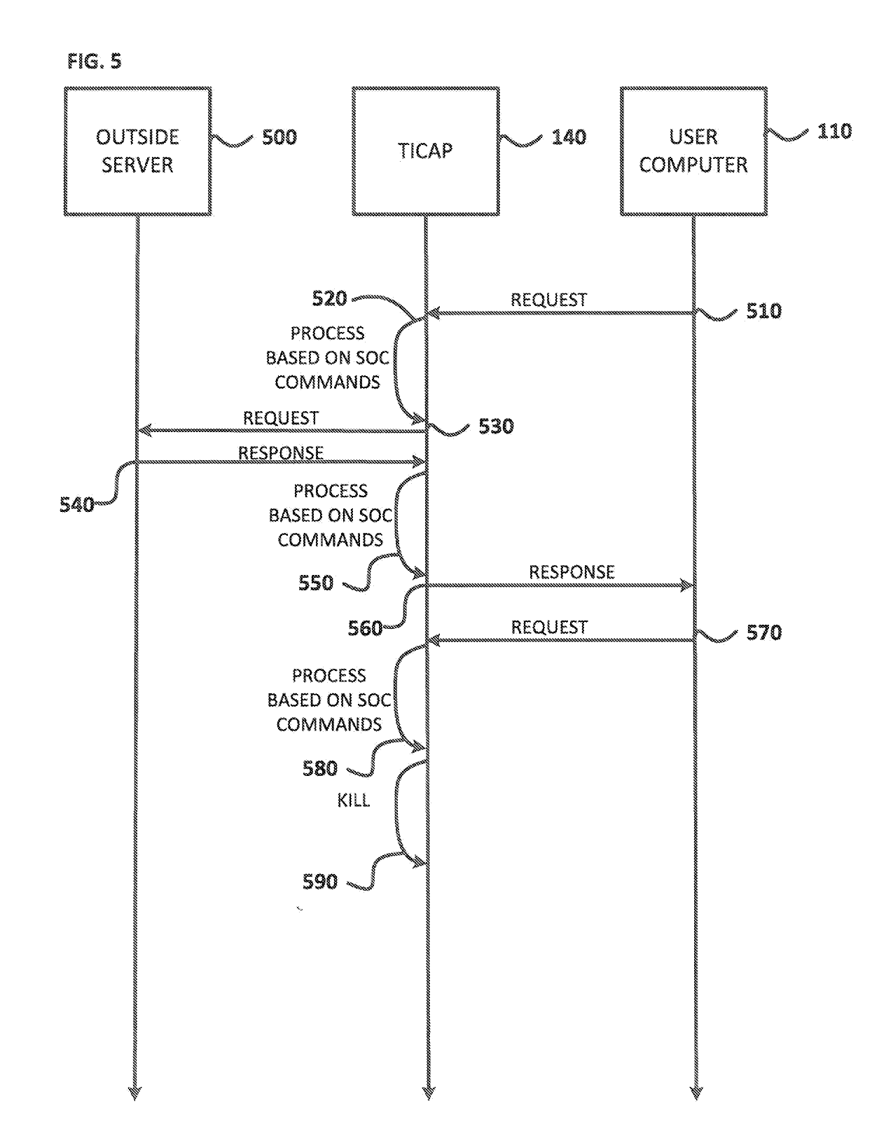

FIG. 5 is a flow diagram illustrating example communications in a secure network communication system, consistent with certain disclosed embodiments. The process can begin in 510 when user computer 110 sends a request through TICAP 140 with a destination address of outside server 500. User computer 110 can represent any one of devices 110, 120, or 130 in FIG. 1. TICAP 140 can represent device 140 in FIG. 1 and/or the device that performs the process described in FIG. 3. Outside server 500 can represent a computing device that is outside of the secure network communication system. For example, outside server 500 can represent a website server and the request can be a network data packet that includes a request to access a webpage stored on the website server.

In 520, TICAP 140 can detect the network data packet in the request (e.g., 320 in FIG. 3) and determine an action (e.g., 330 in FIG. 3). For the purposes of this example, TICAP 140 can determine that the network data packet should be allowed (e.g., ALLOW in 340) based on commands received from a SOC (e.g., SOC 150 in FIG. 1) corresponding to rules of a network security policy and can forward the network data packet to outsider server 500 (e.g., 342 in FIG. 3) in 530. For example, the destination IP address of outside server 500 can be an allowed IP address.

In 540, outside server 500 can respond to the request by sending a network data packet (e.g., including a hypertext transfer protocol (HTTP) document) through TICAP 140 with a destination address of user computer 110.

In 550, TICAP 140 can detect the network data packet in the response (e.g., 320 in FIG. 3) and determine an action (e.g., 330 in FIG. 3). For the purposes of this example, TICAP 140 can determine that the network data packet should be allowed (e.g., ALLOW in 340) based on commands received from a SOC (e.g., SOC 150 in FIG. 1) corresponding to rules of the network security policy and can forward the network data packet to user computer 110 (e.g., 342 in FIG. 3) in 560. For example, the source IP address of outside server 500 can be an allowed IP address.

In 570, user computer 110 can send a second request through TICAP 140 with a destination address of an outside device (not pictured).

In 580, TICAP 140 can detect the network data packet in the request (e.g., 320 in FIG. 3) and determine an action (e.g., 330 in FIG. 3). For the purposes of this example, TICAP 140 can determine that the network data packet should be blocked (e.g., BLOCK in 340) based on commands received from a SOC (e.g., SOC 150 in FIG. 1) corresponding to rules of the network security policy and can kill the network data packet (e.g., 344 in FIG. 3) in 590. For example, the destination IP address of the outside device can be a blocked IP address.

While the operations depicted in FIG. 5 have been described as performed in a particular order and by particular devices, the order and devices described are merely an example, and various different sequences of operations can be performed and/or additional or alternative devices can be used, consistent with certain disclosed embodiments. Additionally, the operations are described as discrete steps merely for the purpose of explanation, and, in some embodiments, multiple operations may be performed simultaneously and/or as part of a single computation. Further, the devices are described as discrete devices merely for the purpose of explanation, and, in some embodiments, multiple devices can be used to perform the operations of a described device and/or or a single device can be used to perform the operations of multiple described devices. The operations and devices described are not intended to be exhaustive or absolute, and various operations or devices can be inserted or removed.

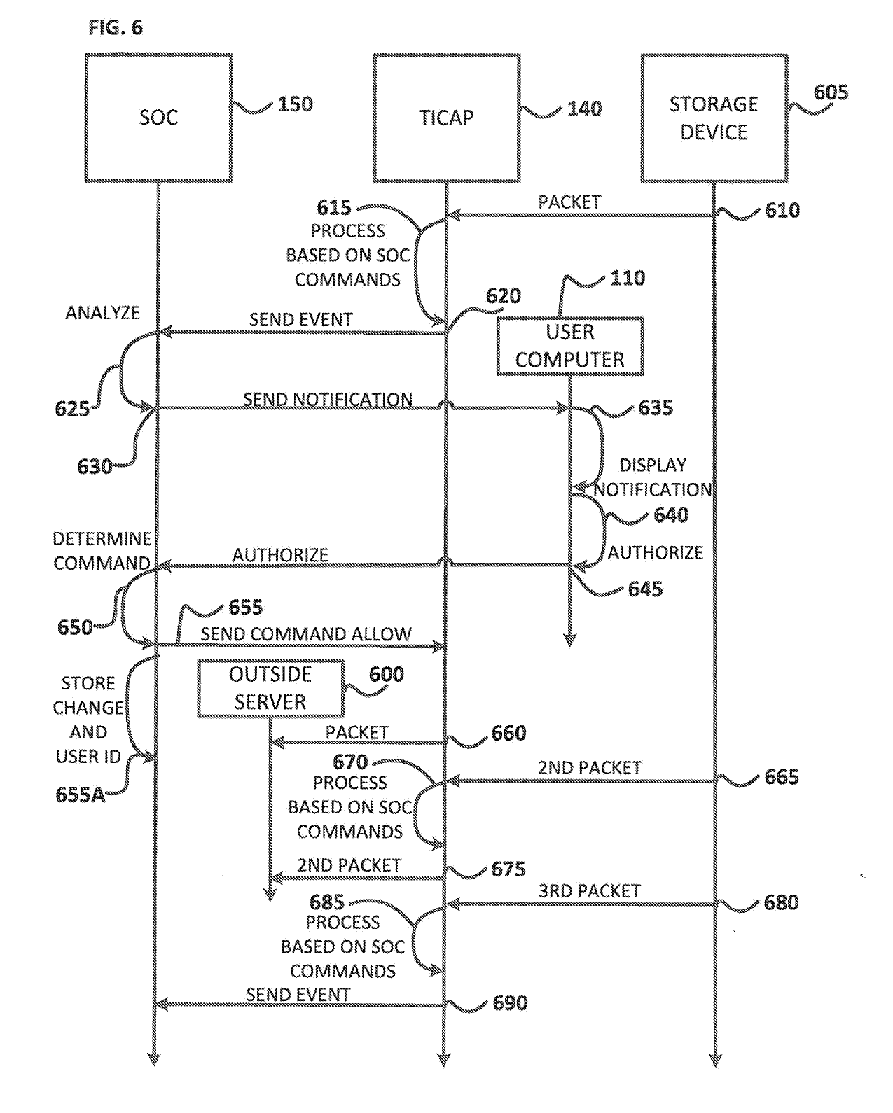

FIG. 6 is a flow diagram illustrating example communications in a secure network communication system, consistent with certain disclosed embodiments. The process can begin in 610 when storage device 605 sends a network data packet through TICAP 140 with a destination address of outside server 600. Storage device 605 can represent a device that stores one or more assets of a company (e.g., a database of files). TICAP 140 can represent device 140 in FIG. 1 and/or the device that performs the process described in FIG. 3. Outside server 600 can represent a computing device that is outside of the secure network communication system. For the purposes of this example, the network data packet can include information about a company asset (e.g., a computer file containing confidential information). The asset can be associated with a department within the company.

In 615, TICAP 140 can detect the network data packet (e.g., 320 in FIG. 3) and determine an action (e.g., 330 in FIG. 3). For the purposes of this example, TICAP 140 can determine that the network data packet triggers a hold (e.g., HOLD in 340 of FIG. 3) based on commands received from SOC 150 corresponding to a network security policy, generate an network security event based on the network data packet, and, in 620, send the network security event to SOC 150. For example, the destination IP address of outside server 600 can be an unknown IP address. SOC 150 can represent device 150 in FIG. 1 and/or the device that performs the processes described in FIG. 2 and/or FIG. 4.

In 625, SOC 150 can receive the network security event (e.g., 400 in FIG. 4), process the network security event using the network security policy that is enforced by rules in the firewall that have been generated from an instance of a distributed network security database that includes, for example, events from network and end points devices, such as user devices, other sensors, global threat intelligence, etc., (e.g., 410 in FIG. 4), and determine an action (e.g., 420 in FIG. 4). For the purposes of this example, SOC 150 can determine to notify user device 110 based on the event (e.g., NOTIFY in 430 of FIG. 4). SOC 150 can determine which user to notify using the database to determine a user that owns an asset associated with the network data packet or using a user authorization hierarchy if the user that owns the asset is unavailable and/or has elected not to receive notifications.

In 630, SOC 150 can send the notification to user computer 110 (e.g., 450 in FIG. 4). User computer 110 can represent any one of devices 110, 120, or 130 in FIG. 1.

In 635, user computer 110 can display the notification, which can permit the user to authorize the network data packet (e.g., permanently or temporarily), deny the network data packet, or defer the decision to another user. For the purposes of this example, the user, via user computer 110, can, in 640, select to authorize the network data packet and authorize similar network data packets for a set period of time (e.g., ten minutes).

In 645, user computer 110 can send a response to SOC 150 (e.g., 460 in FIG. 4) indicating authorization to allow the network data packet and to change the overridable network security controls for ten minutes to allow similar network data packets (e.g., data packets sent to the same IP address).

In 650, SOC 150 can determine commands based on the authorization (e.g., 470 in FIG. 4).

In 655, SOC 150 can, in some embodiments, send the commands to TICAP 140 (e.g., 480 in FIG. 4) to allow the network data packet and to change overridable network security controls of TICAP 140 so that similar network data packets are allowed for ten minutes. Additionally, in 655A, SOC 150 can store an indication of the user that authorized the change and an indication of the change in a log of network security control changes. Accordingly, the user can be held accountable in the event that the change in overridable controls results in a network security failure.

In 660, TICAP 140 can execute the received commands (e.g., 360 in FIG. 3) and forward the network data packet through to outside server 600. For example, TICAP 140 can recreate the network data packet based on information stored corresponding to the network data packet when the hold was determined.

In 665, storage device 605 can send a second network data packet through TICAP 140 with a destination address of outside server 600. In 670, TICAP 140 can determine that the second network data packet is allowed because of the change in overridable controls based on the commands from SOC 150 in 655. Accordingly, in 675, TICAP 140 can forward the second network data packet through to outside server 600.

In 680, after the ten minute window has ended, storage device 605 can send a third network data packet through TICAP 140 with a destination address of outside server 600. However, because the ten minute window has ended, in 685, TICAP 140 can detect the network data packet and determine another hold action, similar to 615. Accordingly, TICAP 140 can generate a network security event based on the third network data packet, and, in 690, send the network security event to SOC 150.

While the operations depicted in FIG. 6 have been described as performed in a particular order and by particular devices, the order and devices described are merely an example, and various different sequences of operations can be performed and/or additional or alternative devices can be used, consistent with certain disclosed embodiments. Additionally, the operations are described as discrete steps merely for the purpose of explanation, and, in some embodiments, multiple operations may be performed simultaneously and/or as part of a single computation. Further, the devices are described as discrete devices merely for the purpose of explanation, and, in some embodiments, multiple devices can be used to perform the operations of a described device and/or or a single device can be used to perform the operations of multiple described devices. The operations and devices described are not intended to be exhaustive or absolute, and various operations or devices can be inserted or removed.

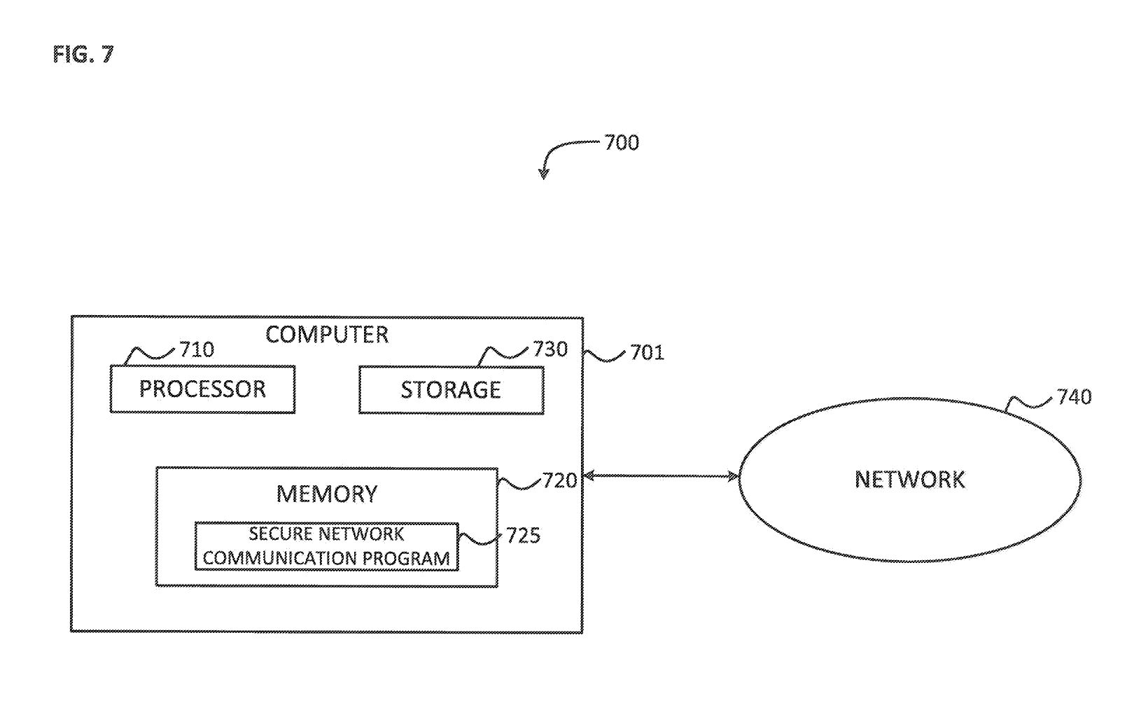

FIG. 7 is a diagram illustrating an example of a hardware system for providing a secure network communication system, consistent with certain disclosed embodiments. An example hardware system 700 includes example system components that may be used. The components and arrangement, however, may be varied.

Computer 701 may include processor 710, memory 720, storage 730, and input/output (I/O) devices (not pictured). The computer 701 may be implemented in various ways and can be configured to perform any of the embodiments described above. In some embodiments, computer 701 can be a general purpose computer of an end user such as, for example, a desktop computer, a laptop, a tablet device, a mobile device (e.g., a smartphone), etc. In other embodiments, computer 701 can be a computing device such as, for example, a database server, a web server, a mainframe computer, etc. For example, computer 701 can be user computer device 110, user mobile device 120, remote computer device 130, TICAP 140, and/or SOC 150 in FIG. 1. Computer 701 may be standalone or may be part of a subsystem, which may, in turn, be part of a larger system.

The processor 710 may include one or more known processing devices, such as a microprocessor from the Intel Core™ family manufactured by Intel™, the Phenom™ family manufactured by AMD™, or the like. Memory 720 may include one or more storage devices configured to store information and/or instructions used by processor 710 to perform certain functions and operations related to the disclosed embodiments. Storage 730 may include a volatile or non-volatile, magnetic, semiconductor, tape, optical, removable, non-removable, or other type of computer-readable medium used as a storage device. In some embodiments, storage 730 can include, for example, one or more knowledge bases, machine-readable rules, an instance of a distributed database, etc.

In an embodiment, memory 720 may include one or more programs or subprograms including instructions that may be loaded from storage 730 or elsewhere that, when executed by computer 701, perform various procedures, operations, or processes consistent with disclosed embodiments. For example, memory 720 may include secure network communication program 425 for initiating a secure network communication system, monitoring communications in a secure network communication system, displaying notifications, and/or receiving user instructions, according to various disclosed embodiments. Memory 720 may also include other programs that perform other functions, operations, and processes, such as programs that provide communication support, Internet access, etc. The secure network communication program 725 may be embodied as a single program, or alternatively, may include multiple sub-programs that, when executed, operate together to perform the function of the secure network communication program 725 according to disclosed embodiments. In some embodiments, secure network communication program 725 can perform all or part of the processes of FIGS. 2, 3, 4, 5, and/or 6 described above.

Computer 701 may communicate over a link with network 740. For example, the link may be a direct communication link, a local area network (LAN), a wide area network (WAN), or other suitable connection. Network 740 may include the internet, as well as other networks, which may be connected to various systems and devices.

Computer 701 may include one or more input/output (I/O) devices (not pictured) that allow data to be received and/or transmitted by computer 701. I/O devices may also include one or more digital and/or analog communication I/O devices that allow computer 701 to communicate with other machines and devices. I/O devices may also include input devices such as a keyboard or a mouse, and may include output devices such as a display or a printer. Computer 701 may receive data from external machines and devices and output data to external machines and devices via I/O devices. The configuration and number of input and/or output devices incorporated in I/O devices may vary as appropriate for various embodiments.

Example uses of the system 700 can be described by way of example with reference to the embodiments described above.

While the teachings has been described with reference to the example embodiments, those skilled in the art will be able to make various modifications to the described embodiments without departing from the true spirit and scope. The terms and descriptions used herein are set forth by way of illustration only and are not meant as limitations. In particular, although the method has been described by examples, the steps of the method may be performed in a different order than illustrated or simultaneously. Furthermore, to the extent that the terms “including”, “includes”, “having”, “has”, “with”, or variants thereof are used in either the detailed description and the claims, such terms are intended to be inclusive in a manner similar to the term “comprising.” As used herein, the term “one or more of” with respect to a listing of items such as, for example, A and B, means A alone, B alone, or A and B. Those skilled in the art will recognize that these and other variations are possible within the spirit and scope as defined in the following claims and their equivalents.

What is claimed is:

1. A method comprising:
sending a risk assessment template to a user device;
receiving a response to the risk assessment template comprising a list of one or more assets;
determining a score for each of the one or more assets based on the response;
determining a network security policy based on the response and the scores using a network security policy computer knowledge base;
determining a network system design based on the network security policy and the response;
determining at least one hardware element and at least one software element based on the network security policy;
determining commands based on the at least one hardware element, the at least one software element, and the network security policy; and
transmitting, using one or more processors, the commands to a security appliance corresponding to the at least one hardware element, whereby the commands cause the security appliance to execute one or more machine-readable rules and security processes corresponding to the network security policy.

2. The method of claim 1, wherein the response to the risk assessment template further comprises a list of one or more personnel corresponding to the one or more assets.

3. The method of claim 1, further comprising determining one or more network security controls based on the network security policy and the response using a network security controls computer knowledge base, wherein the commands are further based on the network security controls.

4. The method of claim 1, wherein determining the network system design comprises using a network system design computer knowledge base to determine one or more virtual domains corresponding to the one or more assets and clustering the one or more virtual domains based on the one or more assets and one or more personnel.

5. The method of claim 1, further comprising testing the security appliance using a testing computer knowledge base by:
sending one or more communications to the security appliance;
receiving one or more responses from the security appliance; and
comparing the one or more responses to the network security policy to determine whether the security appliance passes the testing; and
storing results of the comparing in a database.

6. The method of claim 5, further comprising:
determining that the security appliance passes the testing; and
sending commands to the security appliance to begin operations.

7. The method of claim 5, further comprising:
determining that the security appliance does not pass the testing; and
sending a communication to a device to schedule a fix of the security appliance.

8. The method of claim 1, further comprising:
receiving indications of user device events from the security appliance; and
storing the indications of user device events in a primary instance of a distributed database, wherein security appliances comprise second level instances of the distributed database, network and user devices comprise third level instances of the distributed database, the instances of the distributed database store data used to command security appliances, and the data comprises threat intelligence and security events.

9. A method executed by a security appliance, comprising:
receiving commands corresponding to a network security policy;
executing the commands to establish one or more network security rules;
receiving, from a user device, information corresponding to user device events, wherein the user device comprises an instance of a distributed database;
storing the information in a second instance of the distributed database;
receiving a communication from the user device;
comparing the communication to the one or more network security rules and the information corresponding to the user device events in the second instance of the distributed database;
determining to hold the communication based on the comparing;
transmitting an indication of a network security event based on determining to hold the communication;
receiving a command in response to the transmitting; and
executing the command, using one or more processors, wherein the command causes the security appliance to block or allow the communication.

10. The method of claim 9, wherein the communication includes a network data packet.

11. The method of claim 9, wherein comparing the communication to the one or more network security rules and the information corresponding to the user device events in the second instance of the distributed database comprises correlating the communication to the user device events.

12. The method of claim 9, further comprising holding the communication for subsequent release within a session.

13. The method of claim 9, further comprising:
holding the communication by storing information corresponding to the communication;
ending a session associated with the communication; and
recreating and transmitting the communication in response to the command comprising instructions to allow the communication.

14. The method of claim 9, wherein:
the command comprises instructions to always allow the communication; and
executing the command comprises transmitting the communication and adjusting the network security rules to always allow communications similar to the communication.

15. The method of claim 9, wherein:
the command comprises instructions to allow the communication for a set period of time; and
executing the command comprises transmitting the communication and adjusting the network security rules to allow communications similar to the communication for the set period of time.

16. The method of claim 9, wherein:
the command comprises instructions to block the communication; and
executing the command comprises adjusting the network security rules to block communications similar to the communication.

17. The method of claim 9, wherein:
the communication comprises an indication that the user device is attempting to access a website with a missing certificate; and
executing the command comprises:
attempting to find the missing certificate on the Internet; and
sending a notification to a user device, wherein the notification causes the user device to display an indication of the missing certificate and display a selection option on whether to authorize or deny access to the website.

18. The method of claim 9, wherein the user device events comprise key words counts from one or more communications by the user device in a session, the method further comprising:
accumulating the key word counts into a session count for the session;
accumulating the session count into a daily count and initializing the session count to zero;
accumulating the daily count into a monthly count and initializing the daily count to zero;
accumulating the monthly count into a yearly count and initializing the monthly count to zero, wherein the daily count, the monthly count, and the yearly count are used to establish normal user behavior; and
detecting an anomaly in user behavior based on at least one of the daily count, the monthly count, and the yearly count.

19. The method of claim 9, wherein the user device events comprise internet protocol (IP) address destination counts from one or more communications by the user device, the method further comprising:
accumulating the IP address destination counts into a daily count;
accumulating the daily count into a monthly count and initializing the daily count to zero;
accumulating the monthly count into a yearly count and initializing the monthly count to zero, wherein the daily count, the monthly count, and the yearly count are used to establish normal user behavior; and
detecting an anomaly in user behavior based on at least one of the daily count, the monthly count, and the yearly count.

20. The method of claim 9, further comprising receiving, from the user device, instructions to enable notifications based on network security events.

21. A method comprising:
receiving an indication of a network security event from a security appliance;
comparing the network security event to information in a network security database;
determining to notify a user based on the comparing;
determining, using one or more processors, a user device to notify based on a user authorization hierarchy and an asset corresponding to the network security event;
sending a notification to the user device, wherein the notification causes the user device to display an indication of the network security event and display a selection option on whether to allow or block a communication;
receiving a response from the user device;
determining commands based on the response; and
transmitting the commands to the security appliance.

22. The method of claim 21, wherein the notification includes an option to provide more information about the network security event to the user.

23. The method of claim 21, wherein the response comprises instructions from the user to allow communications similar to a communication associated with the network security event for a set period of time.

24. The method of claim 21, wherein the response comprises instructions from the user to always allow communications similar to a communication associated with the network security event.

25. The method of claim 21, wherein the response comprises instructions from the user to block a communication associated with the network security event.

26. The method of claim 21, further comprising adding an indication of the network security event, an indication of the user device, an indication of the response from the user device, and information corresponding to a user's digital certificate for non-repudiation of the response to a log.
